(19) United States
(12) Patent Application Publication
(10) Pub. No.: US 2023/0260037 A1
(43) Pub. Date: Aug. 17, 2023

(54) WEB, MOBILE AND BROWSER EXTENSION

(71) Applicant: Ava Labs, Inc., New York, NY (US)

(72) Inventors: Nicholas John Mussallem, San Rafael, CA (US); Kevin Sekniqi, Sunny Isles Beach, FL (US)

(21) Appl. No.: 18/167,577

(22) Filed: Feb. 10, 2023

Related U.S. Application Data
(60) Provisional application No. 63/309,423, filed on Feb. 11, 2022.

(51) Int. Cl. G06Q 40/06; H04L 9/00; G06Q 20/36; G06Q 20/40

(52) U.S. Cl. CPC G06Q 40/06; H04L 9/50; G06Q 20/36; G06Q 20/401; H04L 2209/56

(57) ABSTRACT

A system for transacting blockchain assets includes a blockchain engine with an encryption tool configured to generate multiple encryption hashes to create a sequence of encrypted data blocks storing multiple blockchain assets and transactions thereof for multiple users, a wallet tool to process user requests for asset transactions between one or more users of one or more blockchains, facilitating wallet to wallet transactions, wallet to smart contract transactions, and record-keeping, and a statistics tool to provide analytics information about the asset transactions. The system also includes a portfolio management engine with an aggregator tool to aggregate assets for each user and across one or more blockchains to provide to the statistics tool, and a smart contract tool to provide secure contracts for two or more parties involved in the asset transactions. A method for performing asset transactions in blockchains with the above system is also provided.

### CROSS-REFERENCE TO RELATED APPLICATIONS

The present disclosure is related and claims priority under 35 U.S.C. § 119(e), to U.S. Prov. Appln. No. 63/309,423, entitled WEB AND MOBILE BROWSER EXTENSION, to Nicholas John Mussallem, et al. filed on Feb. 11, 2022, the contents of which are hereby incorporated by reference in their entirety, for all purposes.

### BACKGROUND

### Field

The present disclosure is generally related to applications for handling transactions with blockchain assets. More specifically, the present disclosure is directed to browser extensions that enable a web browser to perform transactions with assets of different blockchains seamlessly and securely.

### Related Art

Blockchain networks have become widely available and in use for safely storing assets and perform smart contract operations and other secure and tamper-safe transactions between parties. However, users often find complications when attempting to transfer assets between different blockchains, or even perform transactions thereof. Current attempts to bridge the gap between different blockchains have encountered multiple hurdles in terms of compatibility and network architecture. There is a lack of a comprehensive platform that affords compatibility with multiple blockchain networks and is also flexible in terms of device access (mobile, browser, web-app).

### SUMMARY

In a first embodiment, a system includes a blockchain engine having an encryption tool configured to generate multiple encryption hashes to create a sequence of encrypted data blocks storing multiple blockchain assets and transactions thereof for multiple users, a wallet tool configured to process user requests for asset transactions on the same blockchain or between two addresses of a blockchain, a statistics tool configured to provide analytics information about the asset transactions, a swap tool configured to swap a blockchain asset, a bridge tool to access two or more blockchains, and a buy tool to purchase a blockchain asset using fiat currency. The system also includes a portfolio management engine having an aggregator tool configured to aggregate assets for each user and across two or more blockchains to provide to the statistics tool, a smart contract tool configured to provide secure contracts for two or more parties involved in the asset transactions, and an account management engine including: an address book tool, and an account switch tool.

In a second embodiment, a computer-implemented method includes providing, via an application interface, to a client device with a first user, a list of multiple assets in a first blockchain to which the first user is subscribed, receiving, via the application interface, a request from the first user to perform a transaction involving one or more of the assets in the first blockchain, determining a value for the transaction, and performing the transaction when the first user accepts the value for the transaction.

In a third embodiment, a non-transitory, computer-readable medium storing instructions which, when executed by a processor, cause a computer to execute a method, the method includes providing, via an application interface, to a client device with a first user, a list of multiple assets in a first blockchain to which the first user is subscribed, receiving, via the application interface, a request from the first user to perform a transaction involving one or more of the assets in the first blockchain, determining a value for the transaction, and performing the transaction when the first user accepts the value for the transaction, applying the value for the transaction to an account for the first user, and providing, via the application interface, a display of the account to a wallet tool in an application running in the client device.

In other embodiments, a system includes a first means to store instructions and a second means to execute the instructions to cause the system to perform a method. The method includes providing, via an application interface, to a client device with a first user, a list of multiple assets in a first blockchain to which the first user is subscribed, receiving, via the application interface, a request from the first user to perform a transaction involving one or more of the assets of a second user who is subscribed to the first blockchain, determining a value for the transaction, and performing the transaction when the first user and the second user accept the value for the transaction.

In some embodiments, the system supports subnets as independent blockchains that a third-party can launch, having their own rules regarding membership and token economics.

Accordingly, the system includes validators that verify and achieve consensus on the state of one or more blockchains in the network, regardless which network a user is connected to. In some embodiments, each blockchain is validated by one subnet, and one subnet may handle one or more blockchains. Additionally, one validator may serve one or more subnets. In some embodiments, the system allows users to add a new subnet, interact with that subnet, hide them, and approve transactions between subnets,

These and other embodiments will become clear to one of ordinary skill in light of the following.

### BRIEF DESCRIPTION OF THE FIGURES

FIG. 1 illustrates a network architecture supporting an application for managing blockchain assets, according to some embodiments.

FIG. 2 is a block diagram illustrating devices, components, engines, tools and a mobile application, used in the network architecture of FIG. 1, according to some embodiments.

FIGS. 3A-3L are block diagrams illustrating modules and components in an application for managing blockchain assets, according to some embodiments.

FIGS. 4A-4E illustrate screenshots of an application for managing blockchain assets, according to some embodiments.

FIGS. 5A-5D illustrate screenshots of an asset transaction between blockchains managed via an application, according to some embodiments.

FIG. 6 is a flowchart illustrating steps in a method for transacting blockchain assets, according to some embodiments.

FIG. 7 is a block diagram illustrating a computer system configured to host an application to manage blockchain assets, according to some embodiments.

In the figures, elements having the same or similar reference numeral are associated with the same or similar attributes, unless explicitly mentioned otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Current blockchain networks are heavily fragmented, and users are forced to operate within each specific network without much overlap of resources and capabilities. There is a lack of centralized workflows that provide a consolidated experience to maximize features such as: bridging assets, buying assets, lending assets, swapping assets, and the like, across multiple blockchain networks (or subnets).

Embodiments as disclosed herein, resolve the above technical problem arising in the realm of computer networks, and more specifically blockchain networks, by creating a functionality at the protocol level that allows users to leverage blockchain network assets (e.g., tokens, non-fungible tokens—NFTs—and fungible assets) as validators or to delegate blockchain assets to a third-party validator. Such functionality may be incorporated as a browser add-on, a mobile application, or a web-based application that users can operate from a desktop computer.

In some embodiments, a wallet tool is provided to enable the user to interact with blockchain assets across platforms. The system provides users full control of their assets and the ability to delegate some features to selected third parties. Some functionalities include integration with third-party lending aggregators to provide a gateway for a third-party service within the wallet tool. Some embodiments enable users to link with a third-party lending protocol to sign and execute financial transactions involving one or more assets across blockchain networks. Thus, users participate in lending/borrowing activities with third-party lending protocols. Accordingly, a wallet tool as disclosed herein provides users an aggregated overview of borrow and lend rates across multiple platforms. These lending and borrowing services may be integrated in the application by linking with third-party application programming interfaces (APIs), but users keep the ability to link with liquidity providers or other financial institutions outside of the environment provided herein.

Some embodiments include monetization strategies such as collecting a fee as a percentage of a given transaction amount or receiving a commission from the third-party lending protocol. For example, some third-party payment applications may allow users to pay using their credit card or a blockchain asset transfer. These third-party applications may include a “know your customer” (KYC) process where they collect data directly from the user. A bridging application as disclosed herein may be configured to receive a flat fee or a percentage of the purchase amount, or a commission in fiat according to an agreed schedule.

Embodiments as disclosed herein remove personal identifying information (PII) by use of anonymized IP addresses, hashed public wallet addresses, and device identifiers. In some embodiments, the application uses a third-party service to collect IP addresses, and device identifiers from users at a time of first use (e.g., when users launch the product and create their wallet). The third-party service provider anonymizes the IP address prior to sending to the application for storage/use. The third-party service collects the public wallet address and device identifier, pseudonymizes (e.g., via one-way hash) and sends them to a server hosting the application via an API call. The pseudonymized identifiers are securely stored in a database.

In some embodiments, users will not need to “sign up” to access applications as disclosed herein. Rather, users may download the products and features directly through third-party services. For example, a browser extension may be downloaded through a third-party web store. Similarly, users will be able to download a mobile application through a third-party app store.

Aspects of the present disclosure relate to downloadable computer software for use as a cryptocurrency and digital asset wallet; downloadable computer software for use as a cryptocurrency and digital asset wallet that enables sending, receiving, selling, lending, borrowing and transferring crypto-assets, reading quick response (QR) codes, making purchases, managing contact information of other cryptocurrency and digital asset wallet users, managing user identities, approving user identities, transferring crypto-assets between blockchains and transferring crypto-assets between accounts; hardware cryptocurrency wallet and crypto-asset transaction ledger; downloadable computer software for enabling transactions in a blockchain-based, distributed computing environment including private key management, signing of transactions, staking of tokens of value, creating non-fungible tokens, viewing non-fungible tokens, interacting with non-fungible tokens, acquiring non-fungible tokens, transacting with non-fungible tokens, creating smart contracts, creating subnets, accessing other cryptocurrency wallets, accessing digital asset custody, transfer and settlement platforms controlled by others and for communicating with other cryptocurrency and digital asset wallet users; downloadable web browser software for accessing and navigating blockchain-based networks; downloadable software application for accessing and navigating distributed computing platforms; downloadable software for interfacing between web browser software and blockchain-based distributed computing platforms.

Aspects of the present disclosure also relate to financial services, namely, crypto-asset and related data transfer services featuring blockchain technology; crypto-asset and related data transfer services featuring blockchain technology, namely, transfer of virtual currencies, virtual assets, digital currencies, digital assets, cryptocurrencies and crypto-assets, as well as related data, between and among blockchains; cross-blockchain and inter-blockchain transfer services involving virtual currencies, virtual assets, digital currencies, digital assets, cryptocurrencies and crypto-assets as well as related data; financial services, namely, cross-blockchain and inter-blockchain transfer and communications services involving financial and related data; financial information services provided online, namely, providing information about financial transactions involving cryptocurrencies and crypto-assets; financial information services, namely, providing a searchable online database of information about financial transactions involving cryptocurrencies and crypto-assets including status of transactions, sources and destinations of assets transacted and nature of financial assets transacted.

Aspects of the present disclosure also relate to communication services, namely, inter-blockchain and cross-blockchain data communication; communication services, namely, inter-blockchain and cross-blockchain communication of data representing virtual currencies, virtual assets, digital currencies, digital assets, cryptocurrencies, crypto-assets; communication services, namely, electronic transmission of data among blockchains and distributed ledgers; communication services, namely, electronic transmission of data representing virtual currencies, virtual assets, digital currencies, digital assets, cryptocurrencies and crypto-assets among blockchains and distributed ledgers. For example, some embodiments disclosed herein support the use of third-party hardware wallets to enable a user to store/encrypt their private keys on the hardware wallet and sign transactions using the hardware wallet, while using the system as the interface.

Aspects of the present disclosure also relate to providing internet-based services that enable inter-blockchain and cross-blockchain data communication; providing internet-based services that enable the transfer of data from one blockchain or distributed ledger to another; providing internet-based services that enable inter-blockchain and cross-blockchain transfer of virtual currencies, virtual assets, digital currencies, digital assets, cryptocurrencies and crypto-assets; providing internet-based services that enable the transfer of virtual currencies, virtual assets, digital currencies, digital assets, cryptocurrencies and crypto-assets from one blockchain or distributed ledger to another; providing online non-downloadable computer software for use as a cryptocurrency and digital asset wallet; providing online non-downloadable computer software for use as a cryptocurrency and digital asset wallet that enables sending, receiving, selling, lending, borrowing and transferring crypto-assets, reading quick response (QR) codes, making purchases, managing contact information of other cryptocurrency and digital asset wallet users, managing user identities, approving user identities, transferring crypto-assets between blockchains and transferring crypto-assets between accounts; providing online non-downloadable computer software for enabling transactions in a blockchain-based, distributed computing environment including private key management, signing of transactions, staking of tokens of value, creating non-fungible tokens, viewing non-fungible tokens, interacting with non-fungible tokens, acquiring non-fungible tokens, transacting with non-fungible tokens, creating smart contracts, creating subnets, accessing other cryptocurrency wallets, accessing digital asset custody, transfer and settlement platforms controlled by others and for communicating with other cryptocurrency and digital asset wallet users; providing online non-downloadable web browser software for accessing and navigating blockchain-based networks; providing online non-downloadable software application for accessing and navigating distributed computing platforms; providing online non-downloadable software for interfacing between web browser software and blockchain-based distributed computing platforms.

It is understood that the above aspects are exemplary only, and additional aspects may be included without departing from the scope of the disclosure.

According to aspects, the present disclosure may also apply to subnets and subnet support. Additional aspects include the ability to see, sign, and interact with the Bitcoin and Ethereum chains, among others.

### Example System Architecture

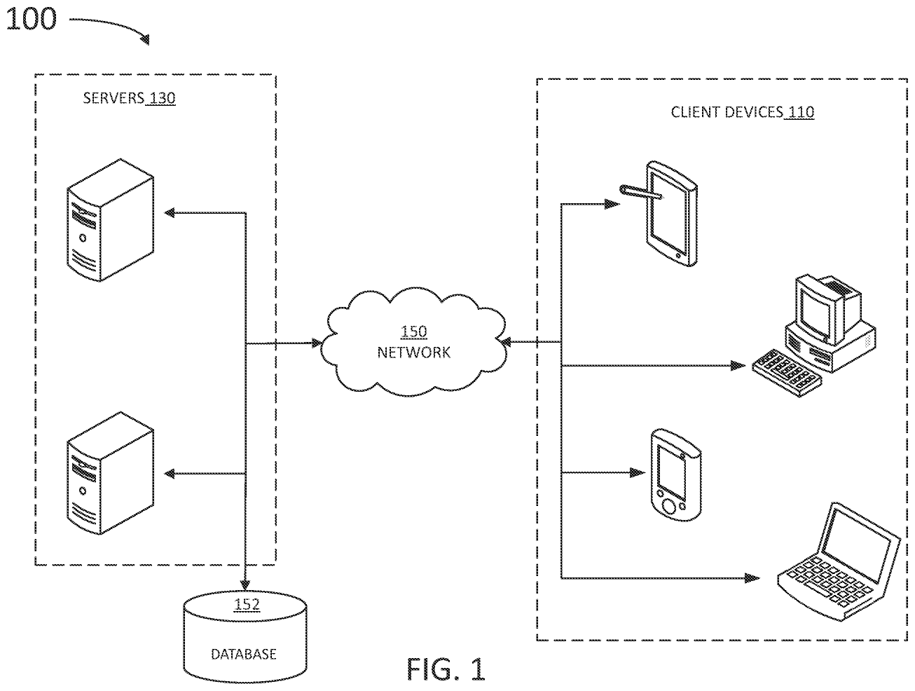

FIG. 1 illustrates a network architecture 100 supporting an application for managing blockchain assets, according to some embodiments. Servers 130 and a database 152 are communicatively coupled with client devices 110 via a network 150. Servers 130 may host applications bridging assets and transactions over multiple blockchains, running in client devices 110. Client devices 110 may be used by users of the bridging applications. Client devices 110 may include smart phones, laptops, mobile devices, palm devices, and even desktops. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like. Database 152 may store backup files from blockchain asset transactions and smart contracts handled through bridging applications running in client devices 110 and hosted by servers 130, including tokens, cryptocurrencies, smart contracts, and financial data. In addition, database 152 may include encrypted keys that may be distributed to each, many, or all of the users of the bridging application.

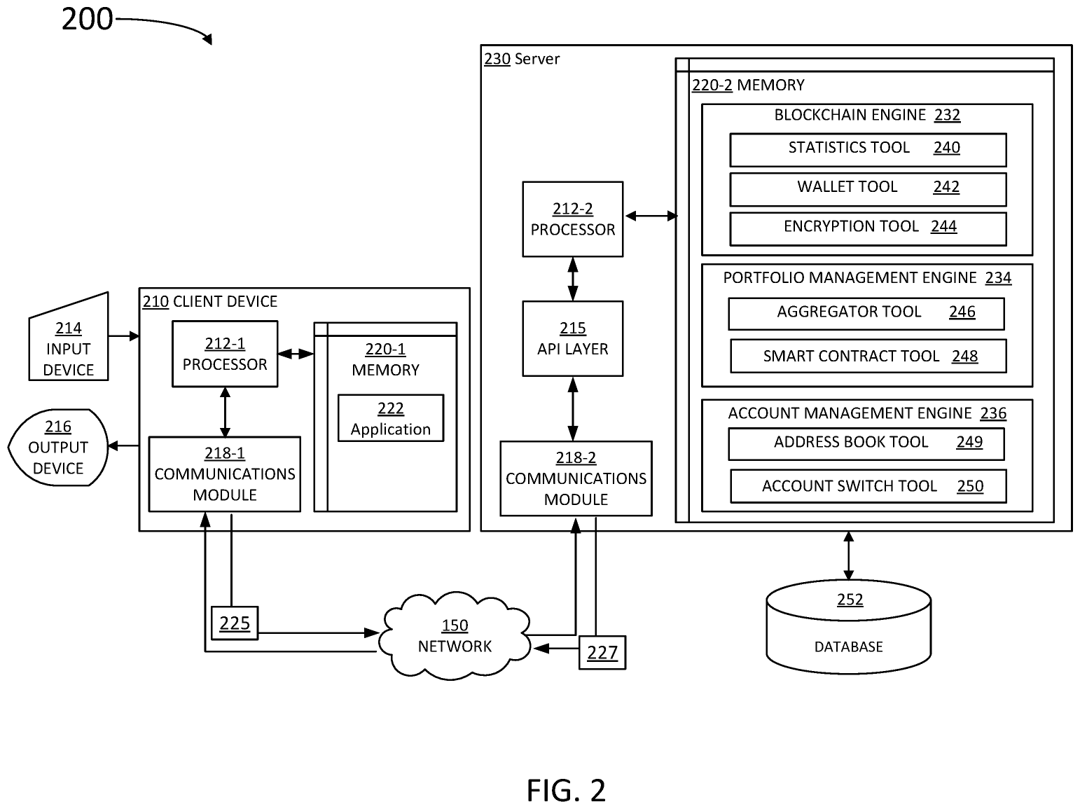

FIG. 2 is a block diagram 200 illustrating client device 210, server 230, components, engines: a blockchain engine 232, and a portfolio management engine 234, and tools: statistics tool 240, wallet tool 242, encryption tool 244, aggregator tool 246, and smart contract tool 248, used in the network architecture of FIG. 1, according to some embodiments. Client device 210 and server 230 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). A user may interact with client device 210 via an input device 214 and an output device 216. Input device 214 may include a mouse, a keyboard, a pointer, a touchscreen, a microphone, a joystick, a virtual joystick, and the like. In some embodiments, input device 214 may include cameras, microphones, and sensors. Output device 216 may be a screen display, a touchscreen, a speaker, and the like.

Client device 210 may include a memory 220-1 and a processor 212-1. Memory 220-1 may include an application 222 (e.g., a blockchain bridge application), configured to run in client device 210 and couple with input device 214 and output device 216. Application 222 may be downloaded by the user from server 230 and may be hosted by server 230. In some embodiments, client device 210 is a desktop computer and application 222 is a browser application having a blockchain bridge add-on, as disclosed herein. In some embodiments, client device 210 is a mobile phone and application 222 is a mobile application. Execution of application 222 may be controlled by processor 212-1. In application 222, communications module 218-1 transmits a user's dataset 225 to server 230, and server 230 may return a dataset 227 to client device 210. Dataset 227 is transmitted via communications module 218-2 from server 230 to one or more users (e.g., different parties in a blockchain transaction, or a smart contract). Accordingly, datasets 225 and 227 may include one or more encrypted signatures that are verified by client device 210 and server 230.

In some embodiments, client device 210 is a desktop computer and application 222 is a browser installed in the computer memory. In some embodiments, client device 210 is a mobile device (e.g., a mobile phone, smart phone, and the like) and application 222 is a mobile application. In some embodiments, application 222 may be a web-based application updated to incorporate most of the features of a browser extension or a mobile application along with new functionality not contained in those products.

Accordingly, application 222 may include a browser extension that enables the user to bridge assets across one or more blockchains serviced by server 230. According to aspects, any third-party browser application may be configured to include a browser extension as disclosed herein. Using the browser extension, users are able to view their assets, send/receive assets, swap assets, and access distributed applications “dApps” deployed on any one of several blockchain networks to which the user subscribes (e.g., buy, bridge, manage NFTs and on-chain portfolio aggregation). The browser extension powers these features by letting users create and manage their own identities (via secret recovery phrases including mnemonics or seed phrases). When a decentralized application 222 wants to perform a transaction and write to the blockchain, the user gets a secure interface to review the transaction before approving or rejecting. The browser extension of application 222 operates by injecting an object into every website's script context (e.g., javascript) so that decentralized applications 222 can interact with a wallet tool 242. This injected context serves as the middleware between wallet tool 242 and application 222.

Server 230 includes a memory 220-2, a processor 212-2, an API layer module 215, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a blockchain engine 232 having a statistics tool 240, a wallet tool 242, and an encryption tool 244. Memory 220-2 may also include a portfolio management engine 234 having an aggregator tool 246 and a smart contract tool 248, and an account management engine 236 including an address book tool 249 and an account switch tool 250. API layer module 215 handles the interface between blockchain engine 232, portfolio management engine 234, account management engine 236 and application 222 in client device 210. In some embodiments, blockchain engine 232, portfolio management engine 234, the tools contained therein, and at least part of training database 252 may be hosted in a different server that is accessible by server 230 or client device 210. Users of client device 210 may access any of the assets included in one or more blockchain networks by a blockchain engine 232, portfolio management engine 234, and the associated tools.

Statistics tool 240 performs statistical analysis and charts associated with blockchain transactions. In some embodiments, statistics tool 240 may determine a value associated with a given blockchain asset, based on an aggregated transaction over network 150.

Wallet tool 242 may enable fiat-to-crypto purchases, and other paid transactions between blockchains. In some embodiments, wallet tool 242 integrates third-party payment applications to enable users to purchase blockchain assets with fiat, tokens, or cryptocurrency, within the same product experience. When the user activates a ‘Buy’ button, wallet tool 242 may be configured to launch the third-party application in a separate window hosted and controlled by a third-party server. Users may complete their transaction entirely within the third-party window. In some embodiments, wallet tool 242 may include tracking of anonymized usage of application features (user clicks, user actions, etc.). Data may be tracked through integration with third-party analytics platforms, or with statistics tool 240.

Encryption tool 244 provides hashes and pairs of public-private keys to users and subscribers of blockchain networks as disclosed herein to access, modify and perform transactions with assets thereof. The transactions are signed by using the hashes and encrypted keys in encryption tool 244.

Aggregator tool 246 is configured to aggregate historical data for a given user over a period of time, across multiple blockchains, or across multiple users (anonymized) and multiple blockchains, according to a selected criterion (token value, terms and conditions of a contract, and the like, locality, or a demographic value). Smart contract tool 248 is configured to handle smart contracts between multiple parties subscribing to the network, or across different blockchains.

Address book tool 249 creates contacts to save frequently used addresses. And account switching tool 250 creates and manages multiple addresses using a same recovery phrase

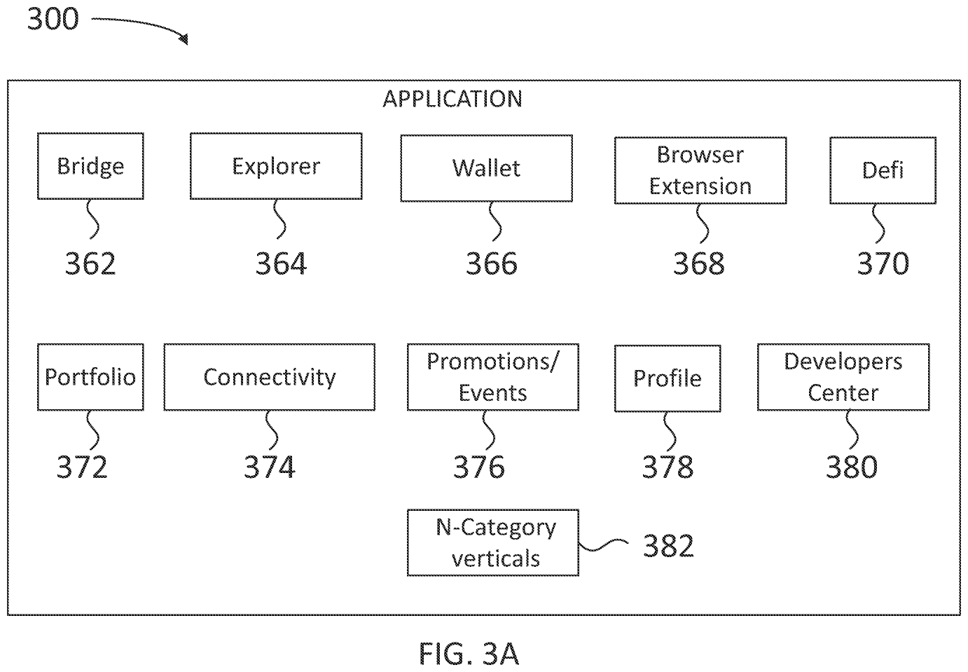

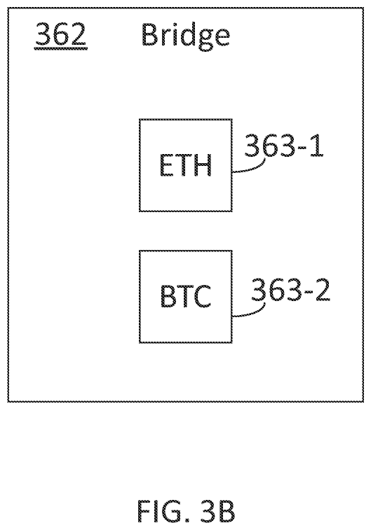

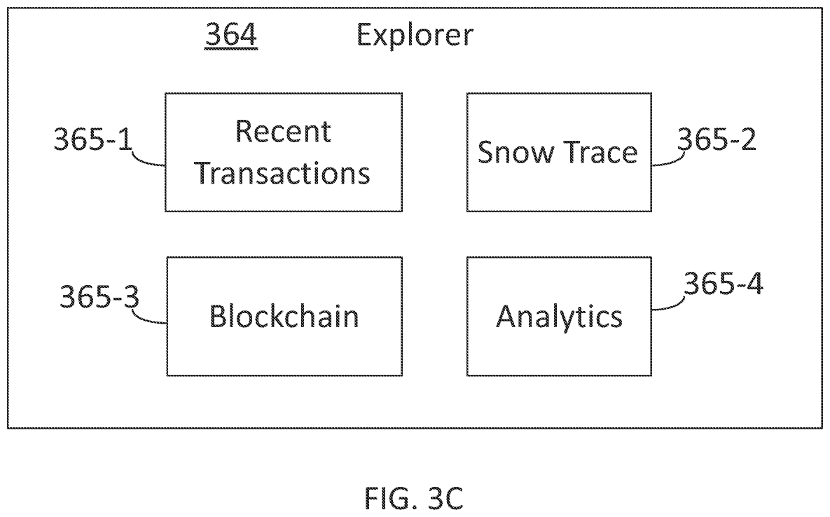

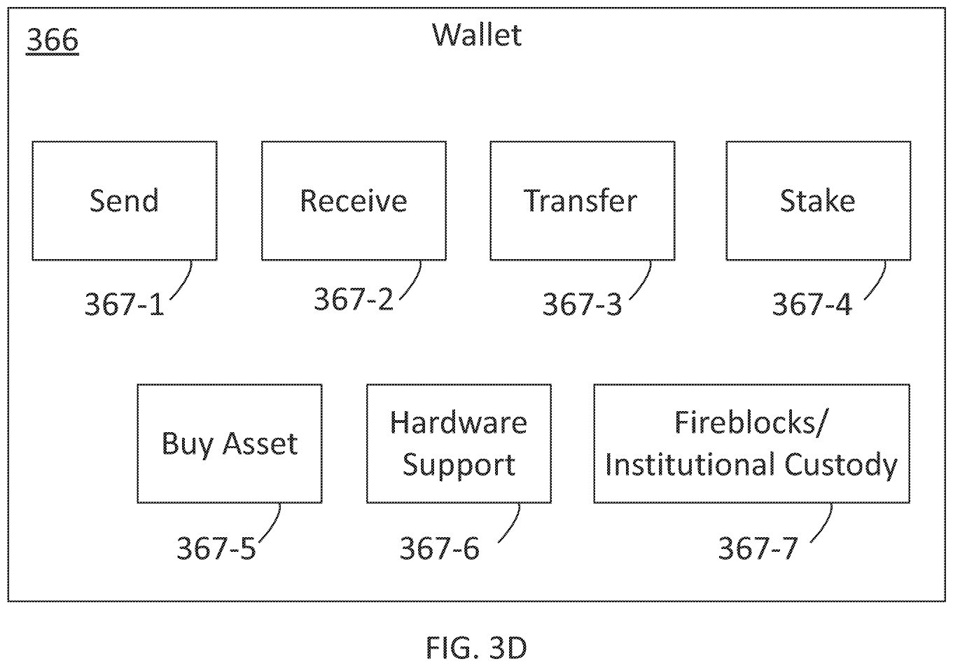

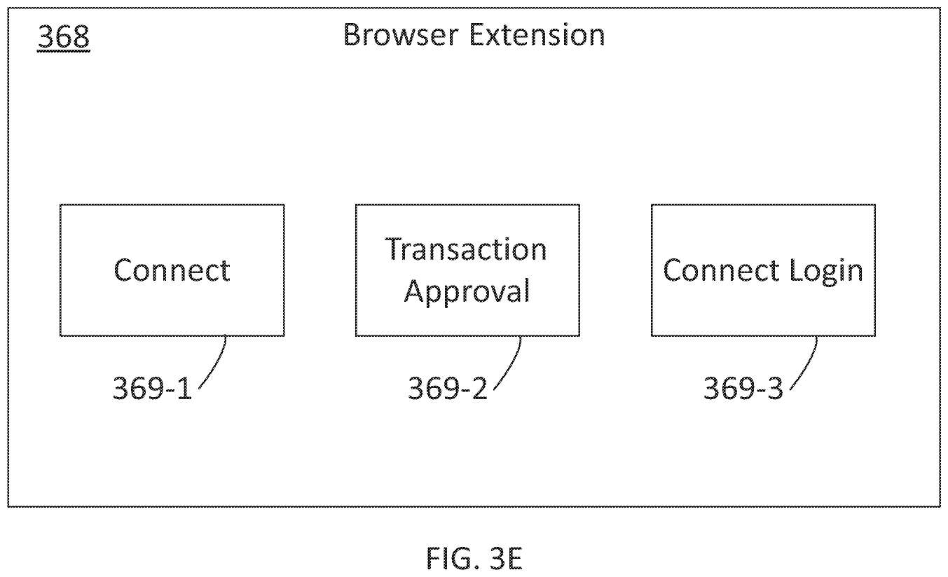

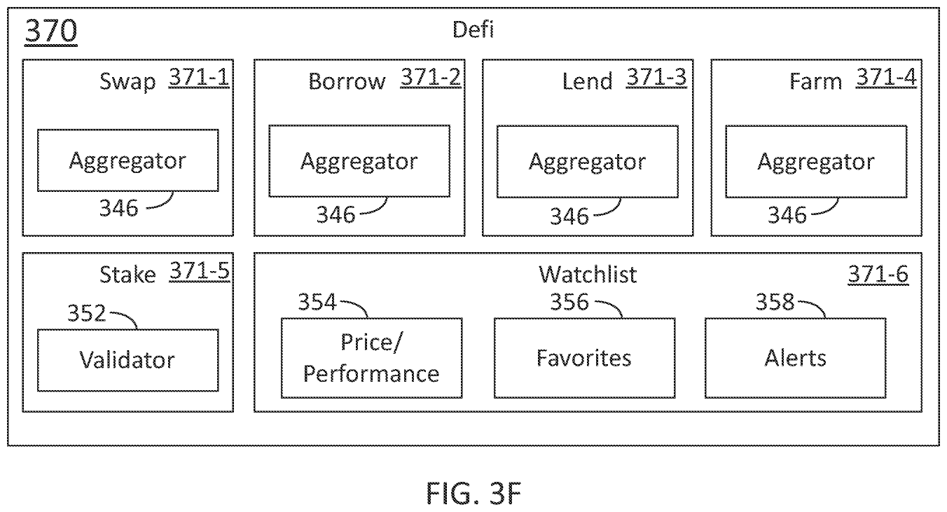

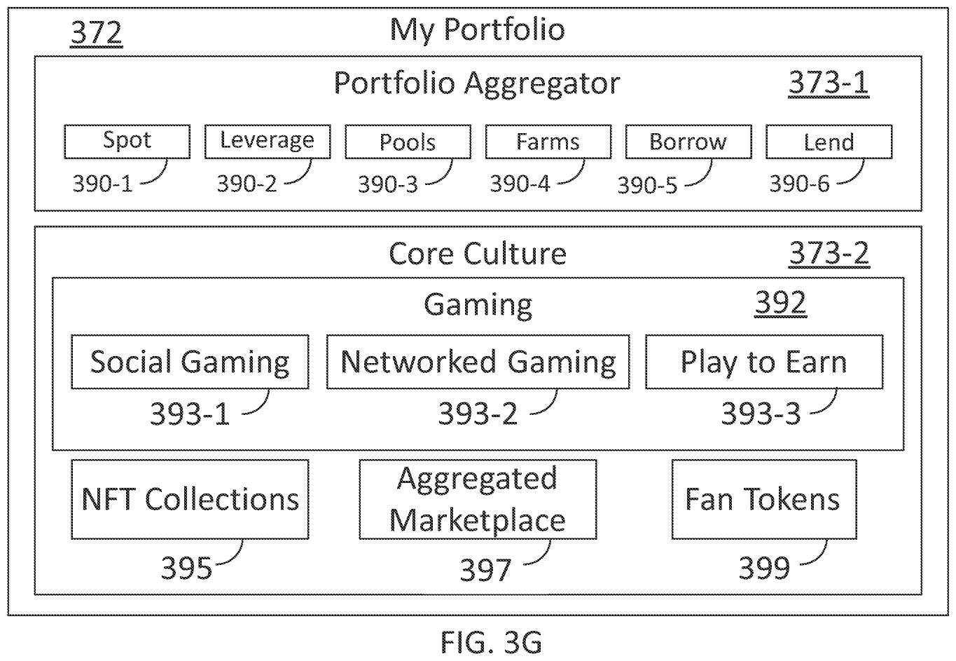

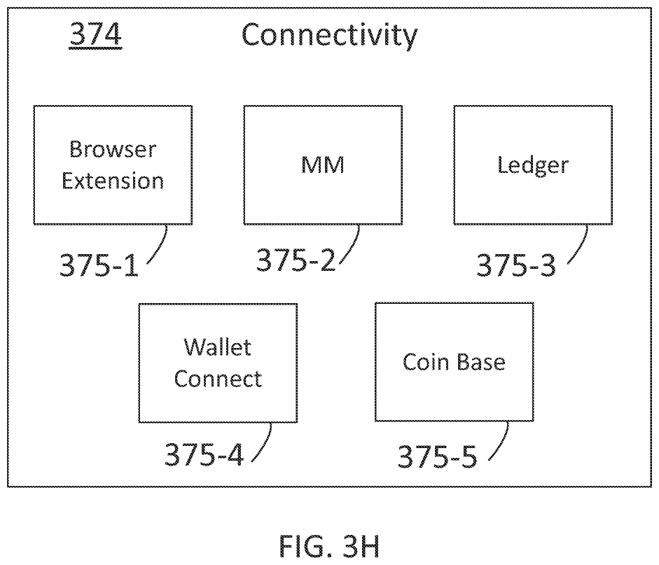

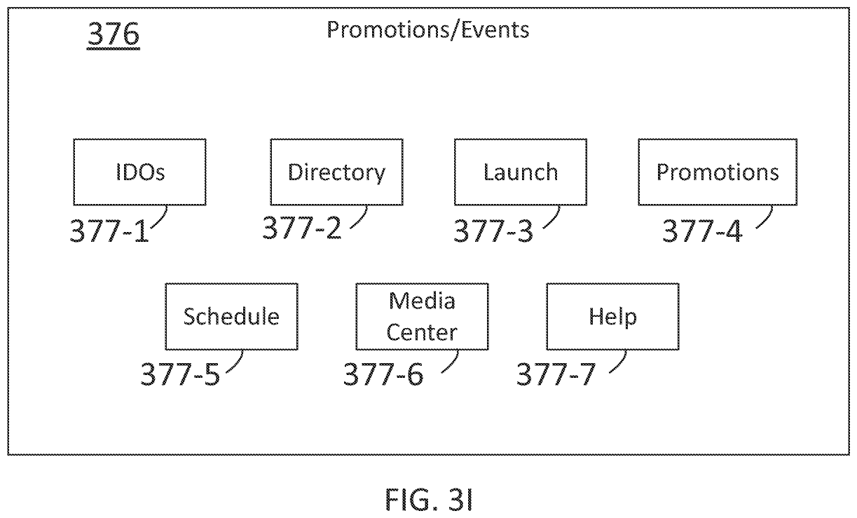

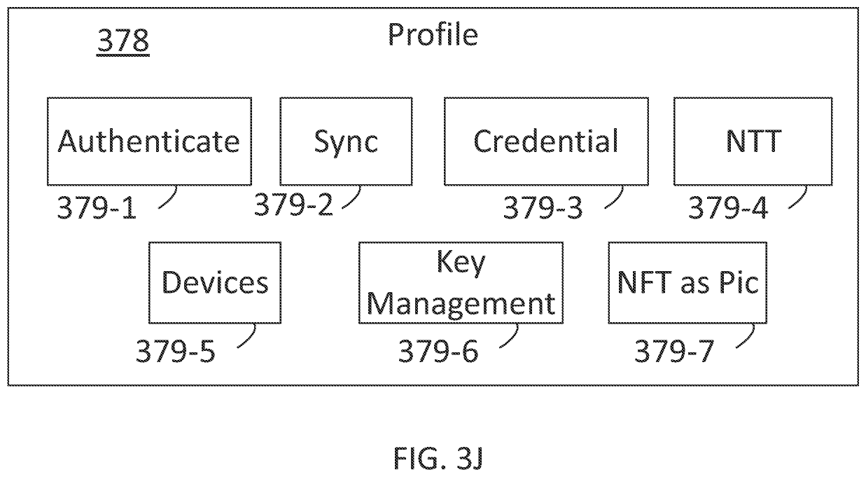

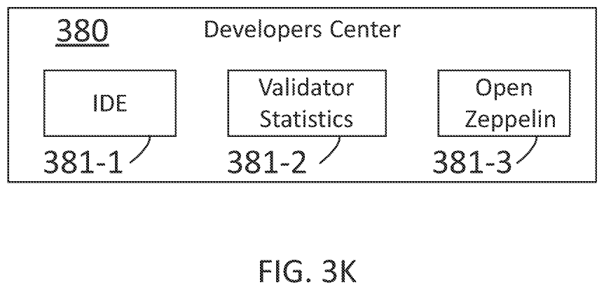

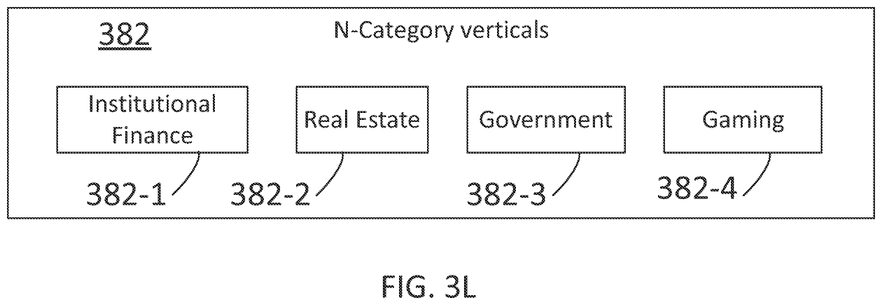

FIGS. 3A-3L are block diagrams illustrating modules 362, 364, 366, 368, 370, 372, 374, 376, 378, 380, and 382 in an application 300 for managing blockchain assets (cf. applications 222), according to some embodiments.

Application 300 for bridging assets from multiple blockchain networks may be installed in a client device, a mobile device, or a server, as disclosed herein. Accordingly, a bridge module 362 establishes a link between the user and two or more blockchains that the user is subscribed to. Bridge module 362 enables users to “transfer” their tokens from a first blockchain to a second blockchain. The transfer uses smart contracts on at least one blockchain. The user locks a first token in the first blockchain. Bridge module 362 then automatically mints a wrapped version of the same token on the second blockchain. An explorer module 364 enables a search query for items within one or more blockchains linked by application 300. A wallet module 366 activates a wallet tool 242 (cf. FIG. 2). A browser extension module 368 provides application 300 as an extension of a browser application already installed in client device 210. A Defi module 370 allows the user to interact with decentralized finance protocols such as to swap assets, lend or borrow assets or participate in other decentralized financial activities. A portfolio module 372 enables users to review and manage their portfolio of assets across different blockchains. A connectivity module 374 verifies security credentials and privileges to access the different blockchains to which users are subscribed. A promotions/events module 376 enables users to promote and generate events for selling, offering, and lending their assets through the network. A profile module 378 stores, sets, and updates user preferences and other settings in application 300. A developers center module 380 enables developers to provide tools and updates to all features in application 300, blockchain engine 232, and portfolio management engine 234 (cf. FIG. 2). And an N-category verticals module 382 that provides a secure sandbox environment allowing third-parties to extend the functionality of the application while leveraging other internal application components.

Bridge module 362 establishes a link between two or more blockchains 363-1 (e.g., Ethereum) and 363-2 (e.g., bitcoin), hereinafter, collectively referred to as “blockchains 363” in application 300. Bridge module 362 may charge a fee for transferring assets between blockchains 363. This fee is used to pay for access to blockchains 363. Users can use/interact with bridge module 362 within wallet module 366 (cf. wallet tool 242) to enable users to perform such transfers.

Explorer feature 364 includes a recent transactions block 365-1. Recent transactions block 365-1 may include: token transfers, token swaps, token staking or delegation, token lending or borrowing (including liquidity provisioning and yield farming), NFT creations, and validator node data bridging transactions and status. Explorer feature 364 also includes a snow trace block 365-2, a blockchain block 365-3, and analytics block 365-4 (hereinafter, collectively referred to as “explorer blocks 365”).

Wallet module 366 includes a send tool 367-1, a receive tool 367-2, a transfer tool 367-3, a stake tool 367-4, a buy asset tool 367-5, and a hardware support tool 367-6. Wallet module 366 may include Fireblocks/Institutional Custody tool 367-7 to enable third parties to perform “know your customer” (KYC) protocols on users, e.g., for institutional use cases and facilitates multi-part computations or multi-signature configurations. Multi-signature may involve third-party wallets that use “m of n” private keys (m≤n) to sign a transaction (e.g., to approve and submit a transaction). For example, when 2 of 3 keys are needed to sign, with each key held by a different person, so two out of three people need to approve the transaction. In some embodiments, wallet module 366 is non-custodial and no KYC protocol is performed. In some embodiments, wallet module 366 incorporates KYC for specific use cases like institutional finance or regulated security offerings that require accredited investors. In some embodiments, wallet module 366 enables crypto-to-crypto swaps integrated with a third-party service to offer a gateway to their service. Some of these third-party services act as an aggregator of decentralized exchanges. In some embodiments, wallet 366 displays a proposed swap rate (e.g., 100 PNG for 1 AVAX, to name any two exemplary blockchain assets), which may be provided by the third-party service. The exchange rate may be updated at a pre-selected rate (e.g., every 45 s, or so) based on market conditions (e.g., bids/asks, liquidity, routing, cf. statistics tool 240). In some embodiments, the third-party may display multiple bids/offers. The application may receive a commission from the third-party service. The commission or fee may be a percentage of the transaction amount. In some embodiments, such details may be negotiated through a smart contract so that fees are automatically collected in real time. In some embodiments, wallet feature 366 allows users to receive “airdrops” (e.g., deposits) from token issuers.

Browser extension 368 includes a connect tool 369-1, a transaction approval tool 369-2, and a connect login tool 369-3 (hereinafter, collectively referred to as browser tools 369). When a user activates browser extension 368 from a browser (e.g., in a desktop device, and the like), the user may access any of the blockchains or subnets linked by the extension and interact with them and their assets through browser tools 369.

Defi module 370 handles games and like applications. Tools and features include a swap tool 371-1, a borrow tool 371-2, a lend tool 371-3, a farm tool 371-4, a stake tool 371-5, and a watchlist tool 371-6 (hereinafter, collectively referred to as “tools 371”). For context, there are different types of blockchain games. Some represent certain gaming assets (e.g., a sword) as NFTs. Others are “play to earn” games where users can earn tokens by taking certain actions in the game. As such, gaming tokens typically take the form of either NFTs of gaming assets (e.g., the sword that can be used in the game or sold to other users) or fungible tokens that are used in the game (e.g., a resource token that allows the user to take certain actions, such as to increase production of other assets or that unlock content in the game). Tools 371-1 through 371-4 may include an aggregator 346 that collects and aggregates anonymized data for selected periods of time, and selected groups of users. Stake tool 371-5 may include a validator 352 that validates the stakes in a game.

Watchlist tool 371-6 may include features that support gaming tokens and related functionality. For example, we may display an aggregated view of gaming token price and performance 354 from gaming token marketplaces, allow users to browse NFT libraries and possibly connect to gaming token marketplaces, select favorites 356, and display alerts 358 based on selected events.

Defi module 370 may also display promotions and launch information of new games and gaming tokens.

My portfolio module 372 includes a portfolio aggregator 373-1 and a core culture 373-2. Portfolio aggregator 373-1 includes a spot tool 390-1, a leverage tool 390-2, a pools tool 390-3, a farms tool 390-4, a borrow tool 390-5, and a lend tool 390-6 (hereinafter, collectively referred to as “tools 390”). Core culture 373-2 includes a gaming sub-module 392 that has a social gaming tool 393-1, a networked gaming tool 393-2, and a play to earn tool 393-3. In addition, portfolio module 372 includes an NFT collections submodule 395, aggregated marketplace submodule 397, and a fan tokens submodule 399. NFT collections submodule 395 allows users to view their collection of NFTs in the wallet (cf. wallet module 366 and wallet tool 242). Aggregated marketplace submodule 397 performs aggregation of initial DEX offerings (IDO) of gaming launches. In some embodiments, submodule 397 displays an aggregated view of new IDOs by gaming protocols, for example sales of resource tokens that can be used in a game. With portfolio module 372, users can send or receive NFTs, view launch announcements of new games and gaming tokens and IDO support, provide access to an aggregated NFT marketplace by integrating with NFT marketplaces, and provide access to an NFT marketplace.

Connectivity module 374 includes a browser extension tool 375-1, a meta-mask (MM)tool 375-2, a ledger tool 375-3, a wallet connect tool 375-4, and a coin base tool 375-5 (hereinafter, collectively referred to as “connectivity tools 375”).

Promotions and events module 376 includes an IDOs tool 377-1 (e.g., upcoming token launches), a directory tool 377-2, a launch tool 377-3, a promotions tool 377-4, a schedule tool 377-5, a media center tool 377-6, and a help tool 377-7 (hereinafter, collectively referred to as “promotions tools 377”).

Profile module 378 includes an authentication tool 379-1, a synchronization tool 379-2, a credential tool (or store) 379-3, an NTT tool 379-4, a devices tool 379-5, a key management tool 379-6, and an NFT tool 379-7 (hereinafter, collectively referred to as “profile tools 379”).

Developers center module 380 includes an IDE tool 381-1, a validator statistics tool 381-2, and an open Zeppelin tool 381-3 to audit smart contracts for security vulnerabilities (hereinafter, collectively referred to as “developers tools 381”).

Verticals module 382 includes an institutional finance tool 382-1, a real estate tool 382-2, a government tool 382-3, and a gaming tool 382-4 (hereinafter, collectively referred to as “verticals tools 382”). Verticals module 382 generally includes functionality specific to different industry sectors

Table 1 below illustrates some monetization schemes for each of the three application modalities disclosed herein (e.g., web, mobile, and browser extension).

TABLE 1
MONETIZATION SCHEMES

| | WEB | MOBILE | BROWSER EXT. |
|---|---|---|---|
| SWAP | Basis point | Basis point | Basis point |
| | model | model | model |
| BUY | Basis point | Basis point | Basis point |
| | model | model | model |
| BRIDGE | Flat fee + | Flat fee + | Flat fee + |
| | estimated | estimated | estimated |
| | blockchain usage | blockchain usage | blockchain usage |
| DEFI | Borrow/Lend at | N/A | N/A |
| | basis point fee | | |
| NFT | Marketplace at | N/A | N/A |
| | basis point fee | | |

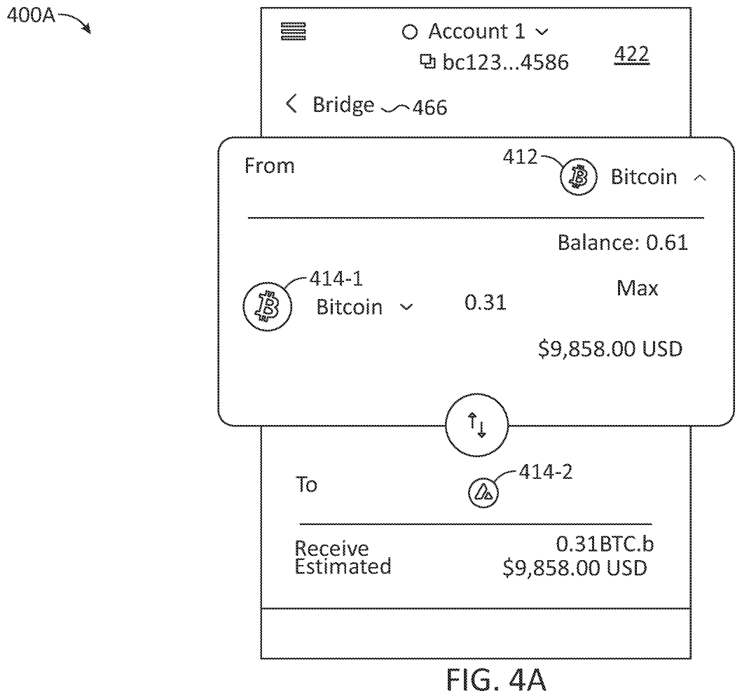

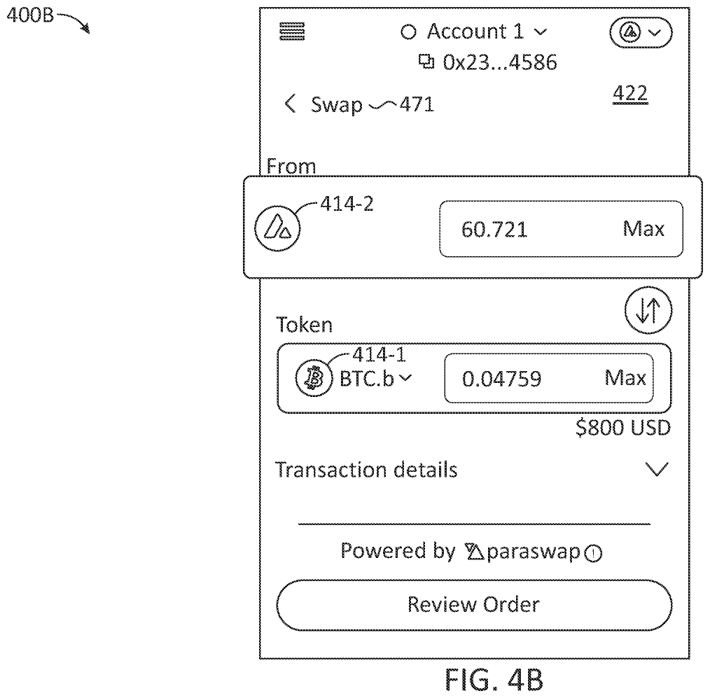

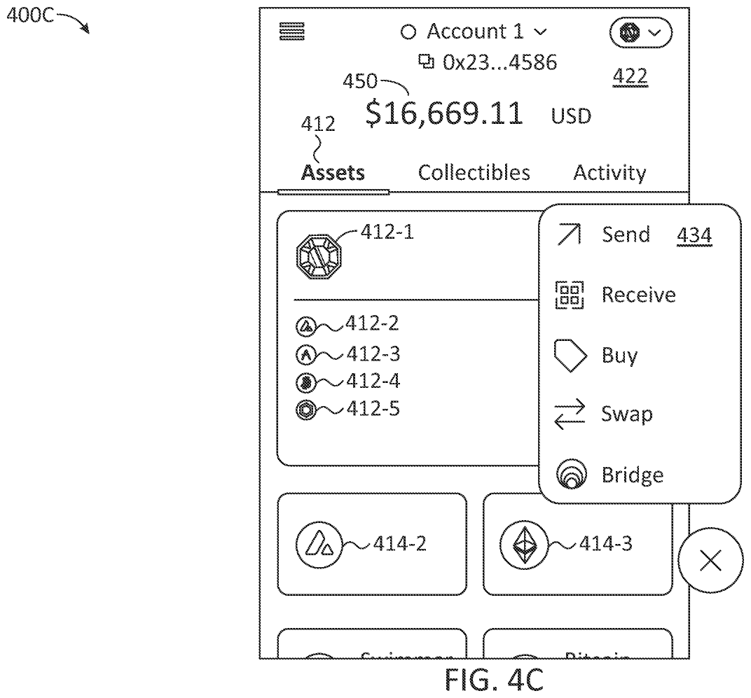

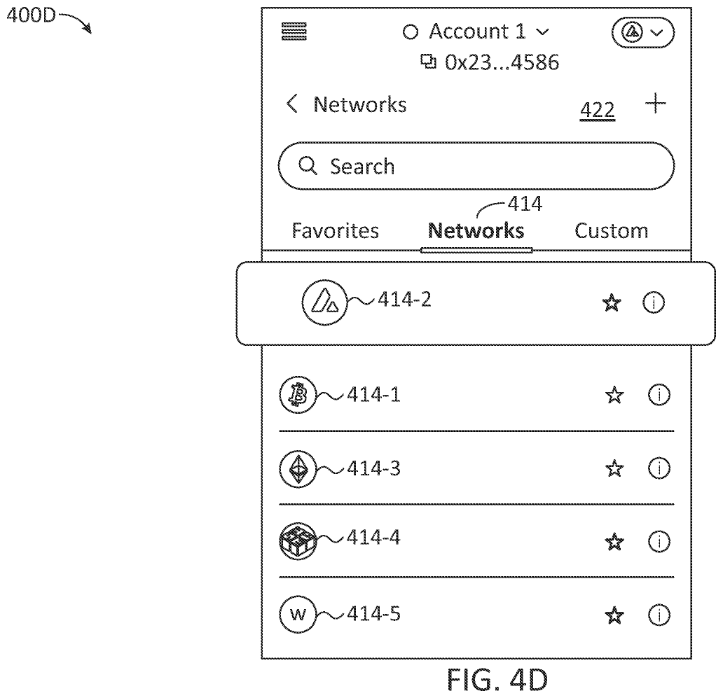

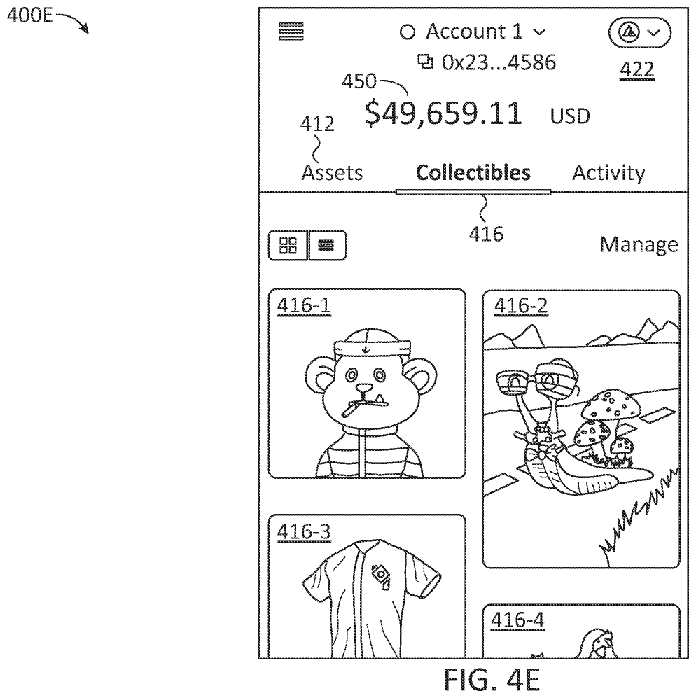

FIGS. 4A-4E illustrate screenshots 400A, 400B, 400C, 400D, and 400E (hereinafter, collectively referred to as “screenshots 400”) of a mobile application 422 for managing blockchain assets 412-1, 412-2, 412-3, 412-4 and 412-5 (hereinafter, collectively referred to as “blockchain assets 412”), according to some embodiments. Application 422 may have access to assets 402 from different blockchains 414-1, 414-2, 414-3, 414-4, and 414-5 (hereinafter, collectively referred to as “blockchains 414”). Application 422 may also include collectibles 416-1, 416-2, 416-3, and 416-4 (hereinafter, collectively referred to as “collectibles 416”). Some screenshots 400 indicate an account balance 450.

Screenshot 400A illustrates a bridge module 466 to link bitcoin assets 412 with a blockchain 414-1.

Screenshot 400B illustrates a swap tool 471 to enable swapping assets between blockchains 414-1 and 414-2.

Screenshot 400C illustrates the use of a credit card or some other financial institution account and funds, to perform certain transactions via application 422. Portfolio management tools 434 includes commands such as “send,” “receive,” “buy,” “swap,” “bridge,” and the like.

Screenshot 400D illustrates a self-custody feature for users to control their assets in application 422.

Screenshot 400E illustrates a management feature for assets in application 422, including bitcoin, NFTs, and the like. In some embodiments, collectibles 416 may include digital designs (pictures, videos, audio files—music, and the like—, GIF files, JPEGs, and the like) or even digital representations of works of art and other collectibles that the user may possess and want to transact with other users. The application allows sending and receiving of non-fungible tokens (e.g., ERC-721s). It also shows users the aggregated floor prices from various marketplaces and allows placing their assets for sale. In some cases, the ERC-721 is linked to a real-world asset and can signify fractional ownership of that asset.

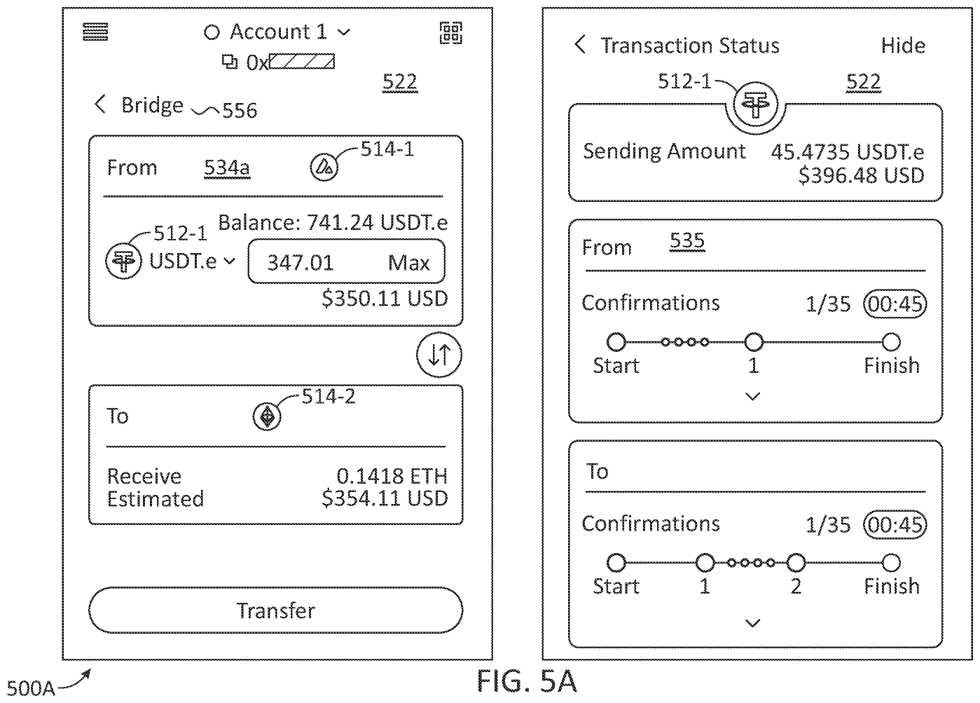

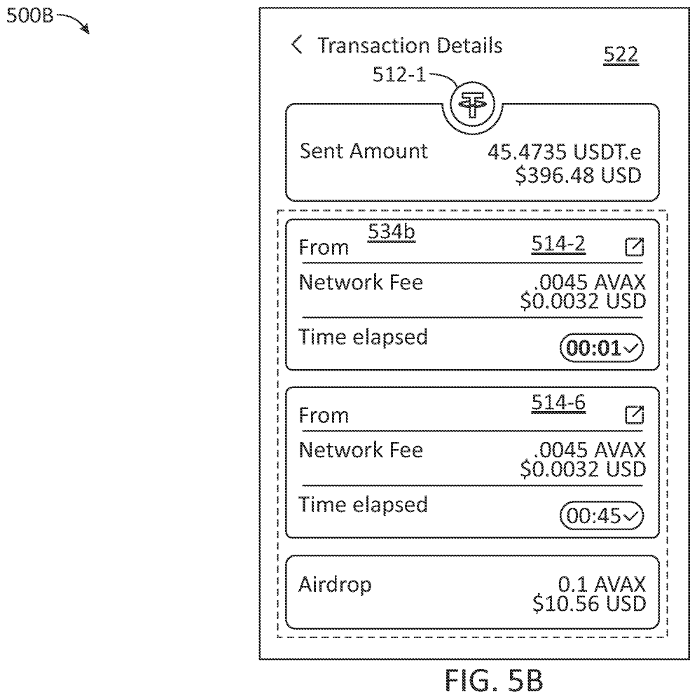

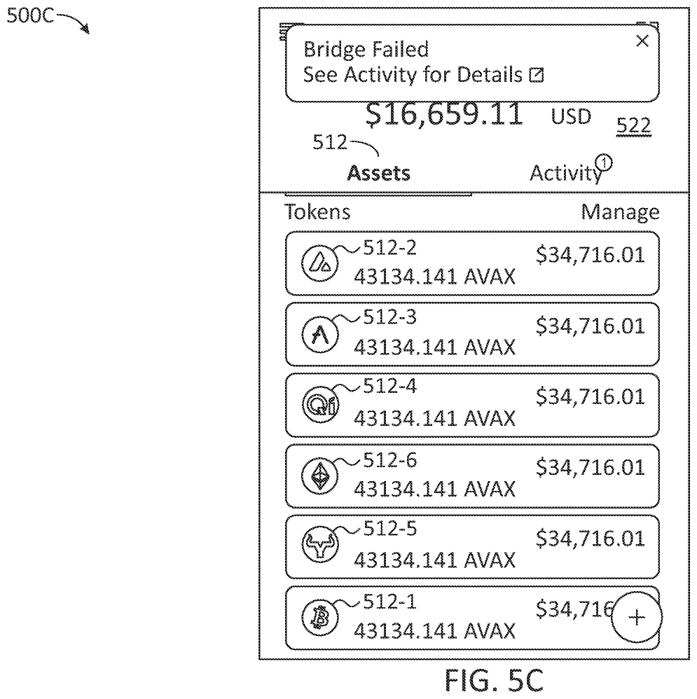

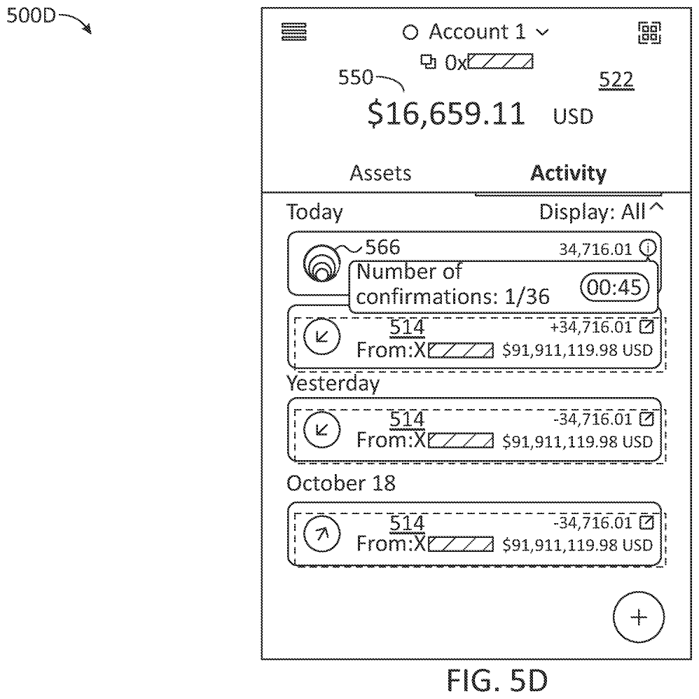

FIGS. 5A-5D illustrate screenshots 500A, 500B, 500C, and 500D (hereinafter, collectively referred to as “screenshots 500”) of an asset transaction or “bridging” between multiple blockchains 514-1 and 514-2 (hereinafter, collectively referred to as “blockchains 514”) managed via a mobile application 522, according to some embodiments. A bridge module 566 links assets 512-1, 512-2, 512-3, 512-4, 512-5, and 512-6 (hereinafter, collectively referred to as “assets 512”) between blockchains 514.

FIG. 5A illustrates a transfer of asset 512-1 between blockchain 514-2 and 514-6. A management field 534a indicates the status 535 of the transfer.

FIG. 5B illustrates transaction details 534b, such as fees and time involved in the transaction.

FIG. 5C is a screenshot of a failed bridge attempt, indicating a listing of assets 512 of the different blockchains available.

FIG. 5D illustrates a display of an account for a user in application 522, wherein bridge tool 566 is not finished updating all the information on blockchains 514-2. An account balance 550 is also illustrated.

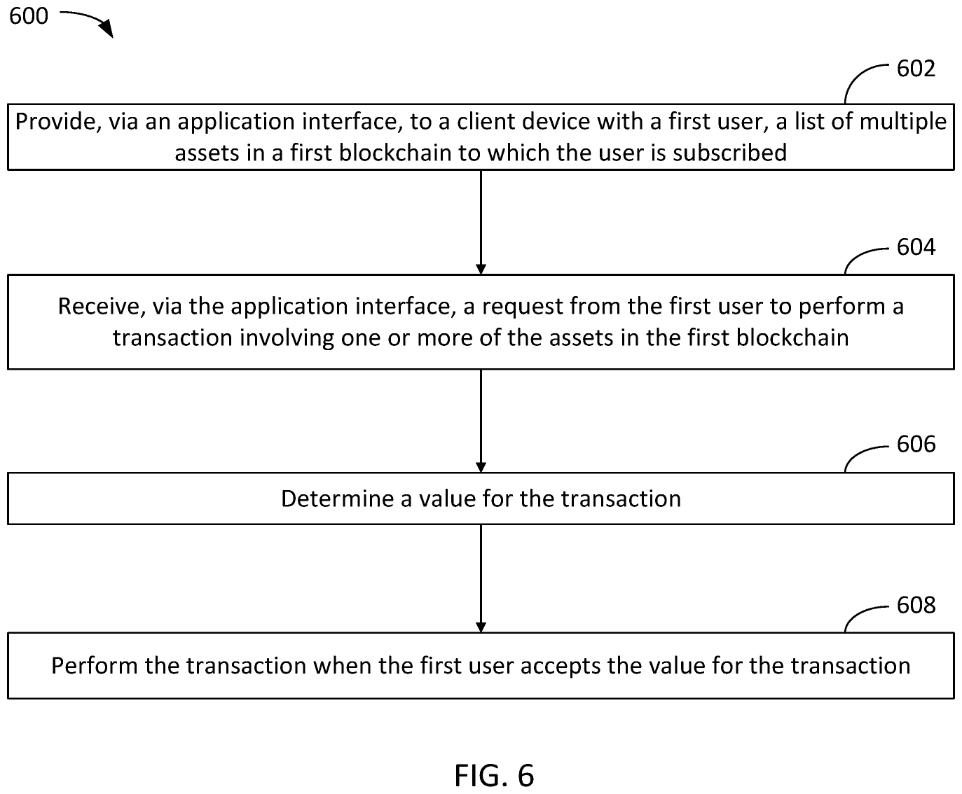

FIG. 6 is a flowchart illustrating steps in a method 600 for transacting blockchain assets, according to some embodiments. In some embodiments, at least one or more of the steps in method 600 may be performed by a client device, a server, or a database communicatively coupled to one another via communications modules, through a network (cf. client devices 110 and 210, servers 130 and 230, databases 152 and 252, communications modules 218, and network 150).

Additionally, some of the steps may be executed by processor circuits executing instructions stored in memory circuits, as disclosed herein (cf. processor circuits 212 and memory circuits 220). In some embodiments, the memory circuits may include an application installed in the client device, interfaced with a blockchain engine, a portfolio management engine or an account management engine in the server via an API layer module (cf. application 222, blockchain engine 232, portfolio management engine 234, account management engine 236, and API layer module 215). The blockchain engine may include instructions from a statistics tool, a wallet tool, and an encryption tool, the portfolio management engine may include instructions from an aggregator tool and a smart contract tool, and the account management engine may include instructions in an address book tool and an account switch tool, as disclosed herein (cf. statistics tool 240, wallet tool 242, encryption tool 244, aggregator tool 246, smart contract tool 248, address book tool 249 and account switch tool 250). In some embodiments, a method consistent with the present disclosure may include only one, or more of the steps in method 600, and performed in a different sequence or order, simultaneously, quasi-simultaneously, or overlapping in time.

Step 602 includes providing, via an application interface, to a client device with a first user, a list of multiple assets in a first blockchain to which the first user is subscribed. In some embodiments, step 602 includes receiving a request for sending, receiving, buying, or swapping one or more user assets in the first blockchain. In some embodiments, step 602 includes receiving a request from the client device to bridge the first blockchain with a second blockchain to which the first user is subscribed. In some embodiments, step 602 includes receiving a request for sending, receiving, buying, or swapping one or more user assets between the first user and a second user.

Step 604 includes receiving, via the application interface, a request from the first user to perform a transaction involving one or more of the assets in the first blockchain.

Step 606 includes determining a value for the transaction. In some embodiments, step 606 includes applying the value for the transaction to an account for the first user, and providing, via the application interface, a display of the account to a wallet tool in an application running in the client device. In some embodiments, the application interface is configured to link with a gaming application in the client device, and step 606 includes associating a user performance in the gaming application into a token value in the first blockchain. In some embodiments, step 606 includes evaluating a non-fungible token in an account of the first user of for the transaction.

Step 608 includes performing the transaction when the first user accepts the value for the transaction. In some embodiments, step 608 includes providing the first user a digital signature of a smart contract before performing the transaction.

### Hardware Overview

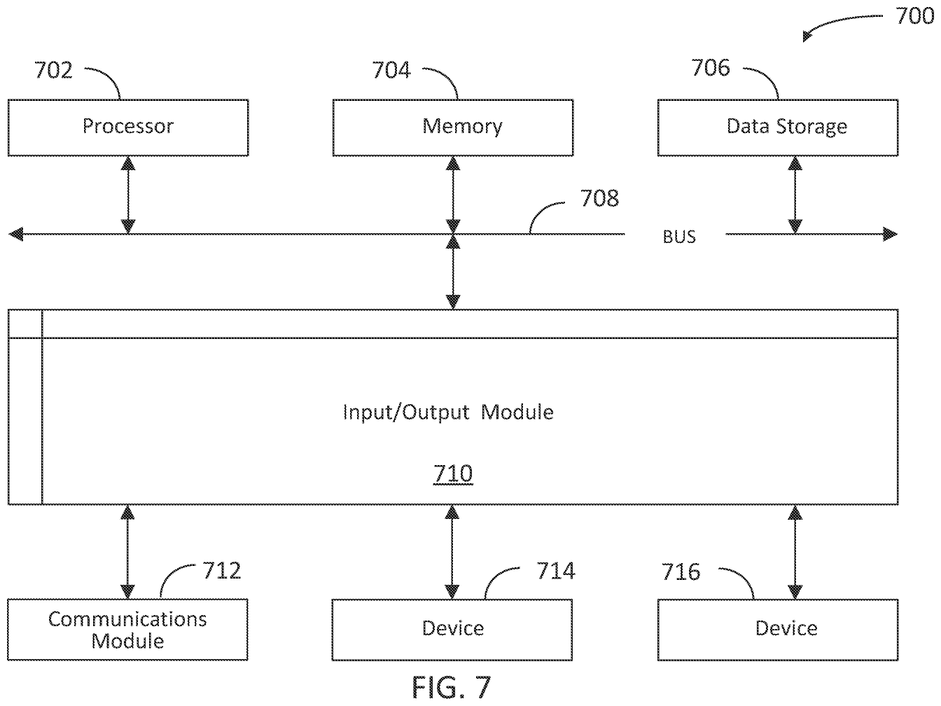

FIG. 7 is a block diagram illustrating an exemplary computer system 700 configured to host an application to manage blockchain assets, according to some embodiments. In certain aspects, computer system 700 may be implemented using hardware or a combination of software and hardware, either in a dedicated server, or integrated into another entity, or distributed across multiple entities. Computer system 700 may include a desktop computer, a laptop computer, a tablet, a phablet, a smartphone, a feature phone, a server computer, or otherwise. A server computer may be located remotely in a data center or be stored locally.

Computer system 700 includes a bus 708 or other communication mechanism for communicating information, and a processor 702 (e.g., processors 212) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer-readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled with bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, input/output module 710 is configured to connect to a plurality of devices, such as an input device 714 and/or an output device 716. Exemplary input devices 714 include a keyboard and a pointing device, e.g., a mouse or a trackball, by which a consumer can provide input to the computer system 700. Other kinds of input devices 714 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 716 include display devices, such as an LCD (liquid crystal display) monitor, for displaying information to the consumer.

According to one aspect of the present disclosure, headsets and client devices 110 can be implemented, at least partially, using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “include” as “include” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A system, comprising:
a blockchain engine, including:
an encryption tool configured to generate multiple encryption hashes to create a sequence of encrypted data blocks storing multiple blockchain assets and transactions thereof for multiple users,
a wallet tool configured to process user requests for asset transactions, including to send and receive assets, between two addresses of a blockchain,
a statistics tool configured to provide analytics information about the asset transactions,
a swap tool configured to swap a blockchain asset,
a bridge tool to access two or more blockchains, and
a buy tool to purchase a blockchain asset using fiat currency;
a portfolio management engine, including:
an aggregator tool configured to aggregate assets for each user and across one or more blockchains to provide to the statistics tool, and
a smart contract tool configured to provide secure contracts for two or more parties involved in the asset transactions; and
an account management engine, including:
an address book tool, and
an account switch tool.

2. The system of claim 1, further comprising a database configured to store the blockchain assets, the asset transactions, and smart contracts associated thereof.

3. The system of claim 1, wherein the blockchain assets include collectible items, and at least one of the collectible items is a digital media file signed by an encryption hash.

4. The system of claim 1, wherein the statistics tool is configured to generate a value for each blockchain asset based on aggregated transaction data over blockchain assets.

5. The system of claim 1, further comprising an application interface configured to link the blockchain engine and the portfolio management engine with a remote server hosting a web-browser application.

6. The system of claim 1, further comprising an application interface configured to link the blockchain engine and the portfolio management engine with an application installed in a mobile device to allow a user of the mobile device to perform blockchain asset transactions.

7. The system of claim 1, further comprising an application interface configured to link the blockchain engine and the portfolio management engine with a web application installed in a client device to allow a user of the client device to perform blockchain asset transactions.

8. The system of claim 1, further comprising an application interface configured to link the blockchain engine and the portfolio management engine with a gaming application installed in a client device to enable a user to play a networked game to earn an income.

9. The system of claim 1, wherein the smart contract tool is configured to request a digital signature from each of the parties to a smart contract, and to store an executed contract in a database, for public access.

10. The system of claim 1, wherein the portfolio management engine further comprises a developer module configured to enable an application developer to provide an application for performing operations with the blockchain assets.

11. A computer-implemented method, comprising:
providing, via an application interface, to a client device with a first user, a list of multiple assets in a first blockchain to which the first user is subscribed;
receiving, via the application interface, a request from the first user to perform a transaction involving one or more of the assets in the first blockchain;
determining a value for the transaction; and
performing the transaction when the first user and the second user accept the value for the transaction.

12. The computer-implemented method of claim 11, further comprising receiving a request from the first user to bridge the first blockchain with a second blockchain to which the first user is subscribed into an application interface.

13. The computer-implemented method of claim 11, wherein receiving a request to perform a transaction comprises receiving a request for sending, receiving, buying, or swapping one or more user assets in the first blockchain to a second user.

14. The computer-implemented method of claim 11, further comprising applying the value for the transaction to an account of the first user, and providing, via the application interface, a display of the account to a wallet tool in an application running in the client device.

15. The computer-implemented method of claim 11, wherein the application interface is configured to link with a gaming application in the client device, and determining the transaction comprises associating a user performance in the gaming application into a token value in the first blockchain.

16. The computer-implemented method of claim 11, wherein determining a value of the transaction comprises evaluating a non-fungible token in an account of the first user.

17. A non-transitory, computer-readable medium storing instructions which, when executed by a processor, cause a computer to execute a method, the method comprising:
providing, via an application interface, to a client device with a first user, a list of multiple assets in a first blockchain to which the first user is subscribed;
receiving, via the application interface, a request from the first user to perform a transaction involving one or more of the assets in the first blockchain;
determining a value for the transaction;
performing the transaction when the first user accepts the value for the transaction; and
applying the value for the transaction to an account for the first user, and providing, via the application interface, a display of the account to a wallet tool in an application running in the client device.

18. The non-transitory, computer-readable medium storing instructions of claim 17 wherein, in the method, receiving a request to perform a transaction comprises receiving a request for sending, receiving, buying, or swapping one or more assets in the first blockchain.

19. The non-transitory, computer-readable medium storing instructions of claim 17, wherein the application interface is configured to link with a gaming application in the client device, and in the method, determining the transaction comprises associating a user performance in the gaming application into a token value in the first blockchain.

20. The non-transitory, computer-readable medium storing instructions of claim 17, wherein the method further comprises providing the first user a digital signature of a smart contract before performing the transaction.
